(19) United States
(12) Patent Application Publication
(10) Pub. No.: US 2024/0061698 A1
(43) Pub. Date: Feb. 22, 2024

(54) MANAGING THE ASSIGNMENT OF VIRTUAL MACHINES TO NON-UNIFORM MEMORY ACCESS NODES

(71) Applicant: VMWARE, INC., Palo Alto, CA (US)

(72) Inventors: VENU MAHESH UPPALAPATI, Bangalore (IN); RIMALPREET SINGH, Jalandhar (IN); ANIL BHARGAV PAINDLA, Bangalore (IN); ADARSH JAGADEESHWARAN, Bangalore (IN)

(21) Appl. No.: 17/990,758

(22) Filed: Nov. 21, 2022

(30) Foreign Application Priority Data
Aug. 19, 2022 (IN) 202241047233

(51) Int. Cl. G06F 9/455; G06F 12/02

(52) U.S. Cl. CPC G06F 9/45558; G06F 12/0284; G06F 2212/2542; G06F 2212/1041; G06F 2009/45583

(57) ABSTRACT

Described herein are systems, methods, and software to manage the assignment of virtual machines to non-uniform memory access (NUMA) nodes of a computing environment. In one implementation, a management service identifies one or more virtual machines in a computing environment with potential NUMA resource issues. The management service further selects a virtual machine from the one or more virtual machines and determines whether a NUMA node associated with the virtual machine satisfies criteria to migrate at least one virtual machine from the NUMA node. If the criteria are satisfied, the management service migrates at least one virtual machine from the NUMA node to a second NUMA node.

### RELATED APPLICATIONS

Benefit is claimed under 35 U.S.C. 119(a)-(d) to Foreign Application Serial No. 202241047233 filed in India entitled “MANAGING THE ASSIGNMENT OF VIRTUAL MACHINES TO NON-UNIFORM MEMORY ACCESS NODES”, on Aug. 19, 2022, by VMware, Inc., which is herein incorporated in its entirety by reference for all purposes.

### BACKGROUND

In computing environments, virtual machines are deployed to use the resources of a physical host computer more efficiently. The hosts use a hypervisor that abstracts the physical hardware of the host and provides that abstracted hardware to each of the virtual machines. The abstracted hardware can include processors, memory, storage, network interfaces, or some other resource. The resources provided to each of the virtual machines can be configured by an administrator based on the requirements of the virtual machines, wherein a first virtual machine can be assigned first resources, while a second virtual machine is provided second resources

In some implementations, hosts can include multiple physical processors, wherein memory access times for each of the processors can be different depending on the portion of memory being accessed. For example, a processor on a host can access a first portion of memory with a first access time, while a second portion of memory can be accessed with a second access time. To ensure that virtual machines are provided an adequate quality of service on the host, a host can be divided into non-uniform memory access (NUMA) nodes that associate faster access memory with one or more corresponding processors (also referred to as processing cores). Thus, a first NUMA node can comprise a first memory portion and first processors, while a second NUMA can comprise a second memory portion and second processors on the same host. However, as computing environments expand and virtual machines are migrated, difficulties can arise in maintaining a desired quality of service, including processor resources and memory resources from a NUMA node for the various virtual machines.

### Overview

The technology disclosed herein manages the assignment of virtual machines to non-uniform memory access (NUMA) nodes. In one implementation, a management service identifies one or more virtual machines in a computing environment with a misconfiguration or overlapping NUMA node resources or assignments. The management service further selects a virtual machine from the one or more virtual machines and determines whether a NUMA node for the virtual machine satisfies one or more criteria. When the NUMA node satisfies the one or more criteria, the management service selects the virtual machine, or another virtual machine associated with the NUMA node for migration.

In at least one example, in selecting the virtual machine from the one or more virtual machines, the management service ranks the one or more virtual machines based on a severity of resource limitations associated with each of the one or more virtual machines. Once ranked, the management service selects the virtual machine with a highest rank.

### BRIEF DESCRIPTION OF THE DRAWINGS

FIG. 1 illustrates a computing environment to deploy virtual machines across non-uniform memory access (NUMA) nodes according to an implementation.

FIG. 2 illustrates a method of operating a management service to migrate virtual machines based on NUMA node requirements according to implementation.

FIG. 3 illustrates an operational scenario of identifying a virtual machine with a misconfiguration or overlapping NUMA node resources on a host according to an implementation.

FIG. 4 illustrates an operational scenario of migrating a virtual machine from a first NUMA node to a second NUMA node according to an implementation.

FIG. 5 illustrates an operational scenario of migrating a virtual machine from a first NUMA node to a second NUMA node according to an implementation.

FIG. 6 illustrates a management computing system to manage virtual machines across NUMA nodes according to an implementation.

### DETAILED DESCRIPTION

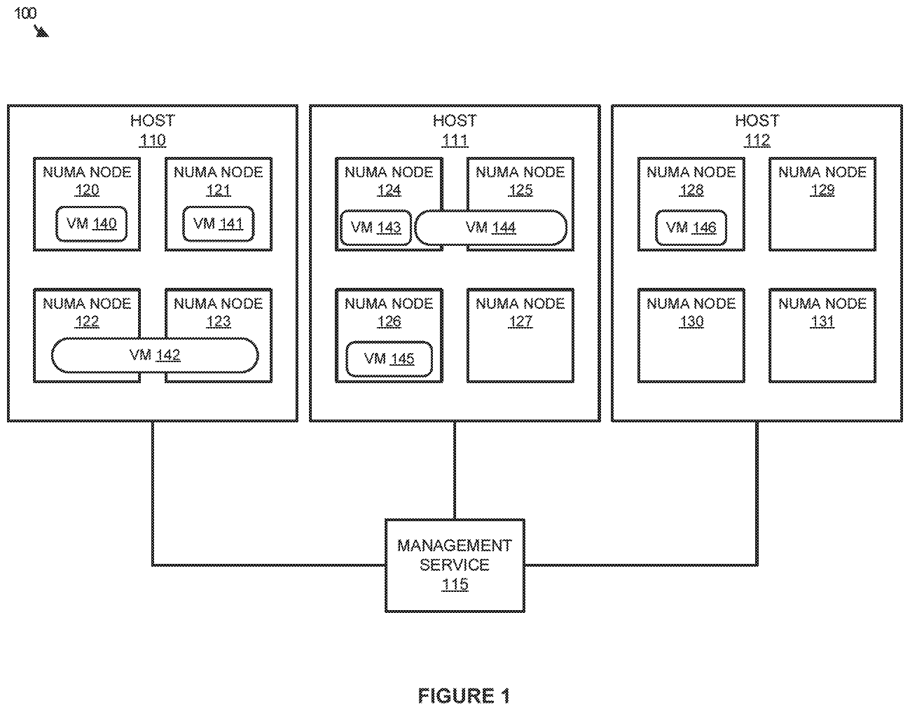

FIG. 1 illustrates a computing environment 100 to deploy virtual machines across non-uniform memory access (NUMA) nodes according to an implementation. Computing environment 100 includes hosts 110-112 and management service 115. Hosts 110-112 further include NUMA nodes 120-131 and virtual machines 140-146. Management service 115 can comprise one or more physical computers or can be implemented at least partially on one or more of the hosts of computing environment 100.

In computing environment 100, hosts 110-112 are deployed to provide a platform for virtual machines 140-146. Hosts 110-112 include a hypervisor that is used to abstract the physical resources and provide the resources to virtual machines 140-146. The resources can include processing resources, memory resources, storage resources, networking resources, and the like. Each virtual machine of virtual machines 140-146 executes its own operating system to support applications and services, such as database applications, data processing applications, or some other application.

Here, to support the execution of virtual machines 140-146, hosts 110-112 are separated into NUMA nodes 120-131. Each NUMA node of NUMA nodes 120-131 contains one or more processors and memory of the corresponding host. For example, NUMA node 120 comprises first processors and memory, while NUMA node 121 comprises second processors and memory. If a virtual machine requires data from memory outside of the NUMA node, the request must use a NUMA interface to access the memory. This access time for data over the NUMA interface is delayed in comparison to the memory local to the NUMA node.

To manage the deployment of the virtual machines to limit the issues of memory access over the NUMA interface or overlapping processing or memory on the NUMA nodes (i.e., multiple VMs assigned to the same NUMA node), management service 115 is provided. Overlapping processing occurs when multiple virtual machines share an affinity to processors and/or memory of a single NUMA node. Management service 115 can monitor the deployment of virtual machines 140-146 in computing environment 100 and determine when migrations are required in association with the virtual machines. In at least one implementation, management service 115 can query the hosts of computing environment 100 to identify one or more virtual machines in the computing environment with a misconfiguration or overlapping NUMA node assignments (i.e., overlapping processing resources and/or memory resources). A misconfiguration can include deploying a virtual machine to a NUMA node with too few processors, deploying a virtual machine to a NUMA node with a memory allocation smaller than the requested memory for the virtual machine, or some other misconfiguration of the virtual machine in computing environment 100. For example, NUMA node 120 may not include enough memory resources to support virtual machine 140. Additionally, management service 115 can identify overlapping NUMA node resources, wherein multiple virtual machines can share the same processors of a NUMA node or share memory resources of a NUMA node. For example, virtual machines 143-144 can be identified for overlapping NUMA node resources, when virtual machines 143-144 share one or more processors of NUMA node 124.

After the one or more virtual machines are identified by management service 115, management service 115 can select a virtual machine from the one or more virtual machines to determine whether the NUMA node for the virtual machine satisfies one or more criteria to trigger a migration of the virtual machine. The one or more criteria can include processing resource usage in association with the NUMA node, memory resource usage in association with the NUMA node, or some other criteria based on the load in association with the NUMA node. For example, NUMA node 124 may satisfy the one or more criteria based on processor resource usage in association with virtual machines 143-144. In response to the NUMA node satisfying the one or more criteria, a virtual machine associated with the NUMA node can be migrated to another NUMA node on the same or different host in the computing environment. In some implementations, the virtual machine for migration can be selected based on the virtual machine with the smallest memory requirement. However, the virtual machine selected for migration can be selected by some other means. Further, when a virtual machine is selected for migration, management service 115 can identify a destination NUMA node for the virtual machine. In at least one example, management service 115 can prefer to migrate the virtual machine on the same host but can migrate the virtual machine to another host when required. When multiple NUMA nodes are available for the migration, management service 115 can select a NUMA node randomly, the NUMA node with the most resources, the NUMA node with the minimum resources for the virtual machine.

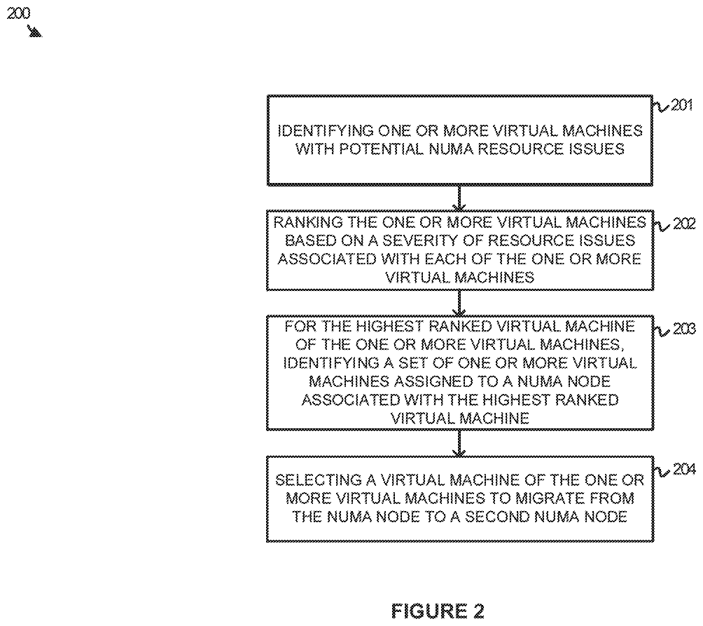

FIG. 2 illustrates a method 200 of operating a management service to migrate virtual machines based on NUMA node requirements according to implementation. The steps of method 200 are referenced parenthetically in the paragraphs that follow with reference to systems and elements of computing environment 100 of FIG. 1. The example will use NUMA node 124 of host 111, however, similar operations can be performed in association with any other virtual machine or NUMA node in computing environment 100.

Method 200 includes identifying (201) one or more virtual machines with potential NUMA resource issues. The potential resource issues can include an overlapping configuration or assignment, wherein one or more virtual machines are assigned the same one or more processors of a NUMA node or share memory associated with the same NUMA node.

Additionally, the potential resource issues can include a misconfiguration, wherein a virtual machine can be assigned to a NUMA node with inadequate resources to support the virtual machine. The inadequate resources can include inadequate processor resources, memory resources, or some other resource in association with the NUMA node. As an example, management service 115 can identify that virtual machine 144 can potentially encounter NUMA resource issues based on the sharing of resources between virtual machines 143-144.

After identifying the one or more virtual machines with potential NUMA resource issues, method 200 further comprises ranking (202) the one or more virtual machines based on a severity of resource issues associated with each of the one or more virtual machines. For example, a first virtual machine may require a first amount of memory, while a second virtual machine can require a second amount of memory. The virtual machine with the larger resource requirement can be prioritized in the ranking. Other examples of resource issues can comprise processing conflicts with other virtual machines (e.g., number of processors in use with other virtual machines), or some other resource related factor.

After the virtual machines are ranked, method 200 further includes, for the highest ranked virtual machine of the one or more virtual machines, identifying (203) a set of one or more virtual machines assigned or associated with a NUMA node associated with the highest ranked virtual machine. Once identified, method 200 comprises selecting (204) a virtual machine of the one or more virtual machines to migrate from the NUMA node to a second NUMA node.

In some implementations, the virtual machine for migration can be selected based on a memory requirement for the virtual machine. For example, management service 115 can identify virtual machines 143-144 sharing NUMA node 124. Once NUMA node 124 is identified, management service 115 can select the virtual machine with the smallest memory requirement on NUMA node. After selection, management service 115 can determine whether removing the virtual machine with the smallest memory requirement provides enough resources to the remaining virtual machine or machines on the NUMA node 124. When removing the virtual machine with the smallest memory requirement on NUMA node 124 permits NUMA node 124 to provide adequate resources to the remaining virtual machines, management service 115 can migrate that virtual machine. Thus, if virtual machine 143 required the least amount of memory from NUMA node 124, then virtual machine 143 can be migrated to a second NUMA node. However, if migrating the virtual machine with the smallest memory resources usage does not permit the remaining virtual machines to operate with the desired resources, then management service 115 can repeat the operations with the virtual machine with the next lowest memory usage. The process can be repeated until a virtual machine is selected that permits the remaining virtual machines to execute on the NUMA node without resource restrictions (e.g., memory or processing).

In some examples, prior to identifying a virtual machine for migration from the NUMA node, management service 115 will first determine whether the resource usage associated with NUMA node satisfies one or more criteria. The one or more criteria can include processor resource usage at the NUMA node exceeding a threshold, memory usage at the NUMA node exceeding a threshold, or some other factor. For example, management service 115 can determine whether memory usage for virtual machines 143-144 on NUMA node 124 exceeds a threshold. If the usage does not exceed a threshold, then no action will be taken in association with the virtual machines. However, if the usage does exceed the threshold, then management service 115 can identify a virtual machine for migration.

After a virtual machine is selected for migration, management service 115 can identify a second NUMA node for the virtual machine. In some implementations, management service 115 first attempts to identify another NUMA node on the same host with processing and memory resources that are required for the virtual machine. If available, management service 115 will initiate the migration to the second NUMA node on the same host, such as NUMA node 127. The migration may include transitioning the processing and memory to physical resources associated with NUMA node 127. If a NUMA node is not available on the same host, then management service 115 can determine whether a NUMA node on any other host includes the resources for the virtual machine. If available, management service 115 can trigger the migration to the NUMA node on another host. If no other NUMA node is available, management service 115 can generate a notification for an administrator indicating that no migration is available from NUMA node 124.

Although demonstrated as ranking the one or more virtual machines to select a virtual machine (and corresponding NUMA node for migration), management service 115 can select the virtual machine from the set of one or more virtual machines using other methods. In one example, management service 115 can randomly select the virtual machine from the set of one or more virtual machines, can select the virtual machine based on a quality of service assigned to the virtual machine, or can select the virtual machine based on some other factor.

In at least one example, instead of selecting the highest ranked virtual machine, management service 115 can generate an interface that demonstrates the ranked list of virtual machines. The ranked list can be based on the severity of resource issues associated with the virtual machine, quality of service assigned to the virtual machine, or some other factor. From the list, a user or administrator can select a virtual machine for resolution from the ranked list, and management service 115 can initiate the migration operations described herein. Specifically, management service 115 can identify a virtual machine to migrate from the NUMA node to resolve the resource issues associated with the administrator selected virtual machine.

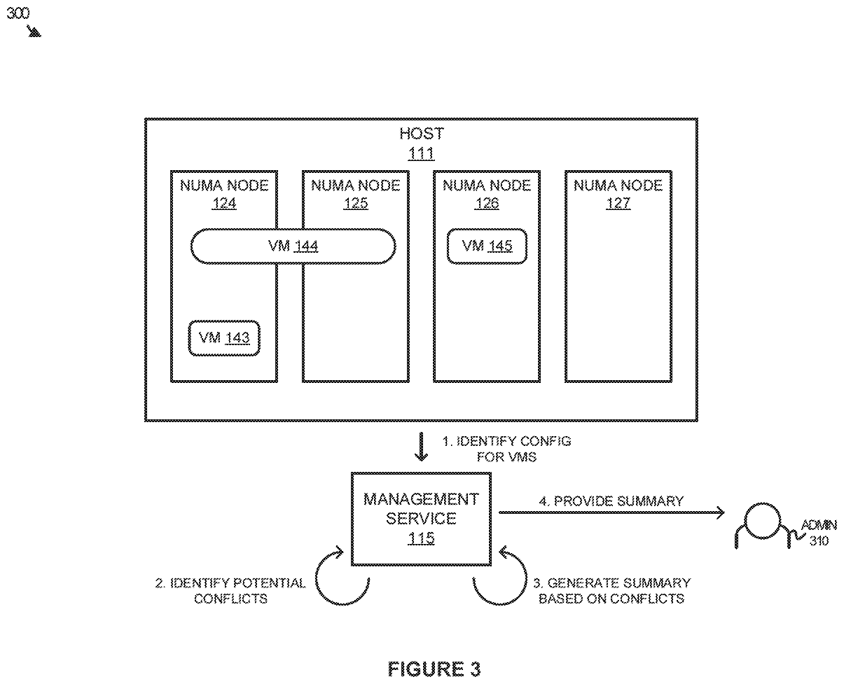

FIG. 3 illustrates an operational scenario 300 of identifying a virtual machine with a misconfiguration or overlapping NUMA node resources on a host according to an implementation. Operational scenario 300 includes host 111 and management service 115. Operational scenario 300 includes administrator 310 that is representative of an administrator or supervising user for computing environment 100.

In operational scenario 300, management service 115 identifies, at step 1, configuration information for virtual machines deployed in the computing environment including host 111. Once identified, management service 115 identifies potential resource conflicts at step 2, such as overlapping virtual machines or misconfigured virtual machines. A misconfigured virtual machine can comprise a virtual machine assigned to a NUMA node with inadequate processor resources or memory resources. For example, virtual machine 145 can be misconfigured if the virtual machine is deployed to a NUMA node without the required processors or memory. In some examples, the misconfiguration information and overlapping resource information can be gathered at least partially from the hosts of the computing environment, wherein the hosts can be queried to identify processor allocations and NUMA node allocations.

After the potential conflicts are identified, management service 115 generates a summary based on the conflicts at step 3 and provides the summary to administrator 310 at step 4. In some examples, the summary can indicate a list of the potential conflict virtual machines (misconfigured or overlapping NUMA resource virtual machines). In some examples, management service 115 can determine whether any of the NUMA nodes meet one or more criteria associated with the load on the NUMA node. The one or more criteria can be a threshold amount of memory usage, a threshold amount of processor usage (e.g., percentage usage), or some other threshold. For example, management service 115 can determine that virtual machines 143-144 cause the memory load associated with NUMA node 124 to exceed a threshold. In response to determining that the memory usage exceeds the threshold, management service 115 can indicate in the summary the one or more NUMA nodes that satisfy the criteria and the corresponding virtual machines. The virtual machines and NUMA nodes can be displayed as a list for the user and can prioritize virtual machines or NUMA nodes based on the severity of the misconfiguration or overlap, can prioritize the virtual machines or NUMA nodes based on the current resource usage, or can prioritize the virtual machines or NUMA nodes in the summary based on some other factor. The NUMA nodes or virtual machines with a higher priority can be displayed with a different font, can be highlighted, placed in a different location in the summary, or can be prioritized in some other manner for the summary to be displayed to administrator 310.

In at least one example, after management service 115 provides the summary list of potentially affected virtual machines, administrator 310 can select a virtual machine from the list for remediation. Management service 115 can then identify a virtual machine from the NUMA node to remedy the conflict or misconfiguration associated with the administrator selected virtual machine and migrate the identified virtual machine to another virtual machine. In some examples, the virtual machine identified for migration comprises a virtual machine that, when removed, remedies the conflict or misconfiguration at the NUMA node. For example, if three virtual machines are assigned or possess and affinity to the same processors, a first virtual machine can be selected for migration that permits the remaining virtual machines to be provided with the required resources for the virtual machines. The first machine can then be assigned to a NUMA node on the same host or a NUMA node on a second host capable of providing the required resources for the first virtual machine.

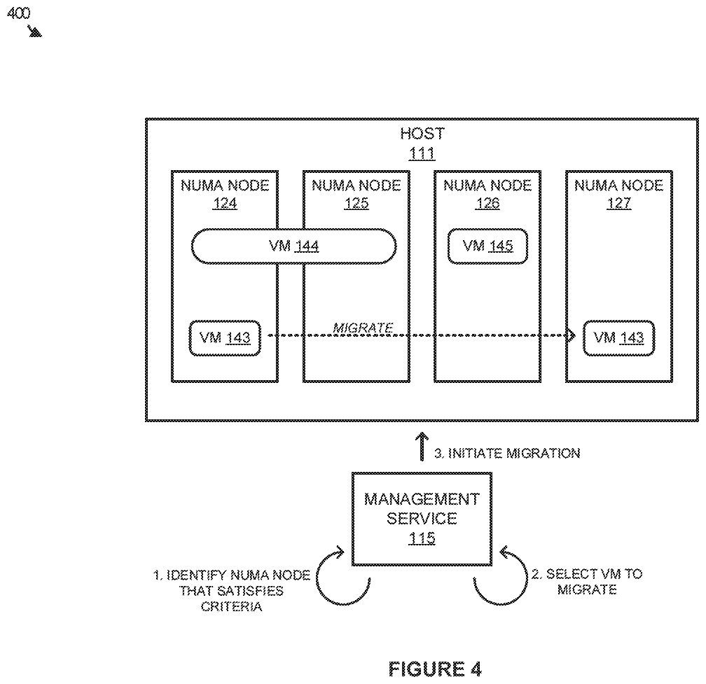

FIG. 4 illustrates an operational scenario 400 of migrating a virtual machine from a first NUMA node to a second NUMA node according to an implementation. Operational scenario 400 includes host 111 and management service 115 from computing environment 100 of FIG. 1.

In operational scenario 400, management service 115 identifies that a virtual machine 143 has potential resource conflicts in association with another virtual machine 144. In response to identifying the potential conflict, management service 115 identifies that NUMA node 124 satisfies one or more criteria to trigger a migration of a virtual machine to another NUMA node at step 1. The one or more criteria may include processor resource usage, memory resource usage, or some other resource usage in association with the NUMA node and the virtual machine. For example, if virtual machine 143 is required to cache data in memory at a second NUMA node of NUMA nodes 125-127, then NUMA node 124 can satisfy criteria to trigger a migration of a virtual machine.

After management service 115 determines that NUMA node 124 qualifies for a migrating virtual machine, management service 115 selects a virtual machine from virtual machines 143-144 to migrate at step 2. In some implementations, management service 115 will select the virtual machine with the lowest current memory requirement at NUMA node 124 and determine whether the migration will reduce the resource usage at NUMA node 124 to satisfy one or more criteria. If the migration satisfies the one or more criteria, management service 115 can initiate a migration of the virtual machine to another NUMA node. If the migration would not satisfy the one or more criteria, management service 115 can try the virtual machine with the next lowest memory requirement and determine whether migrating the virtual machine will satisfy the one or more criteria for the NUMA node. The process can be repeated until a virtual machine is identified for migration that would satisfy the criteria. In operational scenario 400, management service 115 identifies virtual machine 143 for migration.

In some examples, if a single virtual machine is incapable of satisfying the one or more criteria, management service 115 can identify multiple virtual machines for migration in some examples. In other examples, if a single virtual machine is incapable of satisfying the one or more criteria, management service 115 can generate a notification for an administrator of the computing environment.

Once virtual machine 143 is selected for migration, management service 115 selects another NUMA node to support the migrating virtual machine. Here, management service 115 first determines whether another NUMA node on the same host can support virtual machine 143. Management service 115 will consider various factors including the processor capacity of the NUMA node, the memory capacity of the NUMA node, or some other factor. Management service 115 can identify the NUMA node on host 111 with the most resources for the migrating virtual machine or can select any NUMA node with adequate resources to support the migrating virtual machine. In some examples, management service 115 can randomly select the NUMA node from a set of available NUMA nodes on the host. After selecting a NUMA node, management service 115 initiates a migration of virtual machine 143 from NUMA node 124 to NUMA node 127 at step 3. In initiating the migration, management service 115 can communicate with a service on host 111 to migrate the processing and memory resources associated with virtual machine 143 from NUMA node 124 to NUMA node 127, wherein NUMA node 127 can include one or more different processors and memory for the virtual machine.

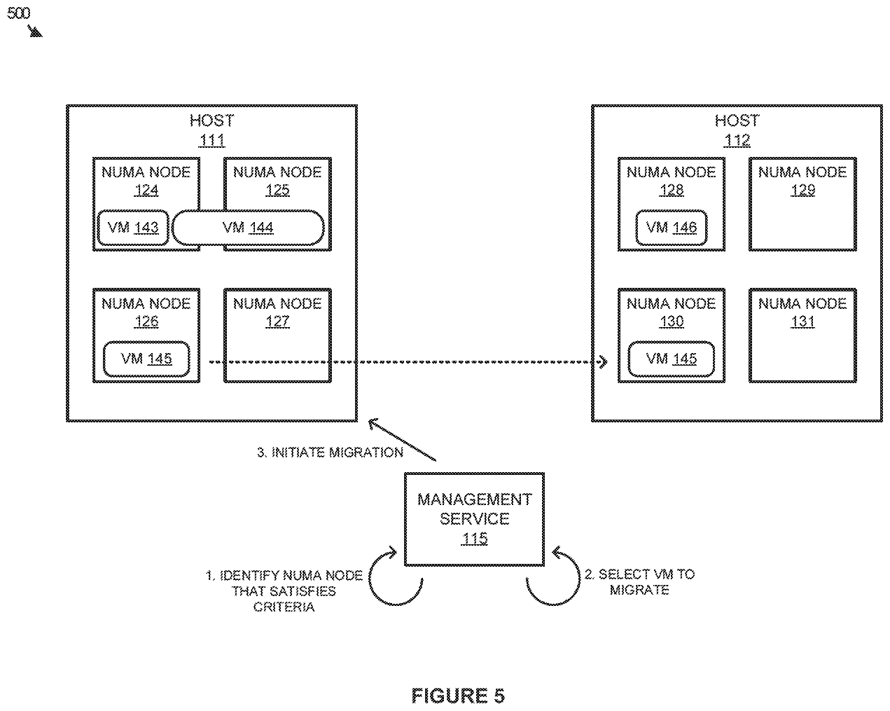

FIG. 5 illustrates an operational scenario 500 of migrating a virtual machine from a first NUMA node to a second NUMA node according to an implementation. Operational scenario 500 includes hosts 111-112 and management service 115 from FIG. 1.

In operational scenario 500, management service 115 identifies that a virtual machine 145 has a misconfiguration associated with the deployment of virtual machine 145 at NUMA node 126. The misconfiguration can comprise NUMA node 126 failing to include adequate processor resources for the virtual machine, NUMA node 126 failing to include adequate memory resources for the virtual machine, or some other misconfiguration. For example, an administrator can configure virtual machine 145 with minimum processor and memory requirements, and management service 115 can determine that the assigned NUMA node 126 is incapable of providing the required resources. Management service 115 can make this determination based at least in part on information supplied from host 111 indicating the available processor and memory resources associated with NUMA node 126.

In response to identifying the misconfiguration associated with virtual machine 145, management service 115 identifies that NUMA node 126 satisfies one or more criteria to trigger a migration of a virtual machine to another NUMA node at step 1. The one or more criteria may include processor resource usage, memory resource usage, or some other resource usage in association with the NUMA node and the virtual machine. For example, if virtual machine 143 is required to cache data in memory at a second NUMA node of NUMA nodes 125-127, then NUMA node 124 can satisfy criteria to trigger a migration of a virtual machine.

After management service 115 determines that NUMA node 124 qualifies for a migrating virtual machine, management service 115 selects a virtual machine to migrate from NUMA node 126 at step 2. In some implementations, management service 115 will select the virtual machine with the lowest current memory requirement at NUMA node 124 and determine whether the migration will reduce the resource usage at NUMA node 126 to satisfy one or more criteria. If the migration satisfies the one or more criteria, management service 115 can initiate a migration of the virtual machine to another NUMA node. If the migration would not satisfy the one or more criteria, management service 115 can try the virtual machine with the next lowest memory requirement and determine whether migrating the virtual machine will satisfy the one or more criteria for the NUMA node. The process can be repeated until a virtual machine is identified for migration that would satisfy the criteria. In operational scenario 400, management service 115 identifies virtual machine 145 for migration as virtual machine 145 is the only virtual machine on NUMA node 126.

After virtual machine 145 is selected for migration, management service 115 selects a NUMA node for migrating the virtual machine. In some implementations, management service 115 will first determine whether a NUMA node exists on host 111 to support to the migration, wherein management service 115 can use factors including processor resources of the other NUMA nodes, memory resources of the other NUMA nodes, or some other factor in relation to the requirements for virtual machine 145. If a NUMA node does exist on host 111, then management service 115 can initiate the migration to another NUMA node on host 111. However, as demonstrated in operational scenario 500, if no NUMA node can support the operation of virtual machine 145, management service 115 can determine whether a NUMA node on another host in the computing environment can support the migrating virtual machine. If multiple NUMA nodes can support the virtual machine, management service 115 can select the NUMA node with the most resources for the virtual machine, can select one of the NUMA nodes at random, can select the NUMA node with the minimum resources for the virtual machine, or can select the NUMA node using some other factor. Here, management service 112 initiates a migration of virtual machine 145 to host 112 and NUMA node 130 at step 3s. In initiating the migration, management service 115 can communicate with services on the host, a hypervisor management service for the computing environment, or some other service capable of supporting the migration of virtual machine to the processor resources and memory resources of NUMA node 130.

Although demonstrated in FIGS. 4 and 5 as identifying a single virtual machine that is misconfigured or is provided an overlapping assignment at a NUMA node, management service 115 can identify a set of virtual machines in the computing environment that are misconfigured or provided overlapping resource assignments at a NUMA node. After identifying the set virtual machines, management service 115 can select a virtual machine from the set based on a priority associated with the virtual machine. The prioritization can be based on the resources required by identified set of virtual machines, a quality of service assigned to the virtual machine, the amount of overlap (i.e., processor or memory overlap) for the set of virtual machines, or some other factor. Once a virtual machine is selected, management service 115 can perform the operations described herein to determine whether a migration is required. The process can then be repeated for any additional virtual machines within the set. In another implementation, when a set of virtual machines is identified, the set can be presented as a user interface to an administrator. The administrator can then select a virtual machine from the set to implement the migration selection and initiation operations described herein. In the user interface, management service 115 can prioritize or rank the set of virtual machines based on the severity of resource limitations associated with the virtual machines (e.g., memory, processors, and the like), the quality of service assigned to each virtual machine in the set, based on the requirements of the virtual machine

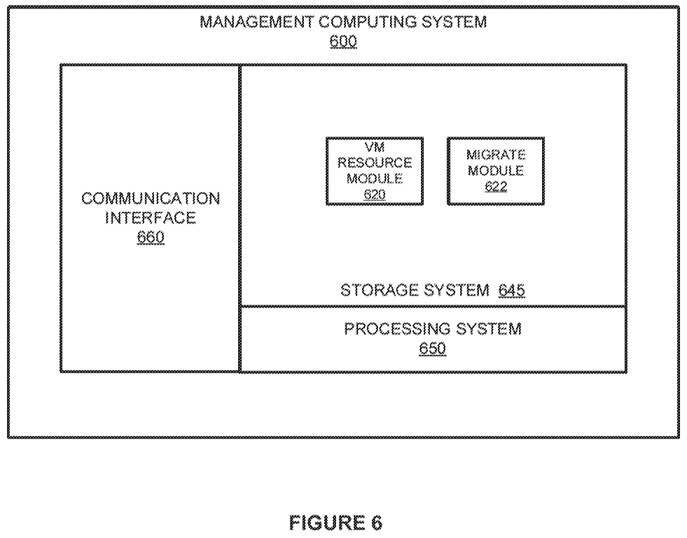

FIG. 6 illustrates a management computing system to manage virtual machines across NUMA nodes according to an implementation. Management computing system 600 is representative of any computing system or systems with which the various operational architectures, processes, scenarios, and sequences disclosed herein for a management service. Management computing node can be implemented system 600 is an example of management service 115 of FIG. 1, although other examples may exist. Management computing system 600 includes storage system 645, processing system 650, and communication interface 660. Processing system 650 is operatively linked to communication interface 660 and storage system 645. Communication interface 660 may be communicatively linked to storage system 645 in some implementations. Management computing system 600 may further include other components such as a battery and enclosure that are not shown for clarity.

Communication interface 660 comprises components that communicate over communication links, such as network cards, ports, radio frequency (RF), processing circuitry and software, or some other communication devices. Communication interface 660 may be configured to communicate over metallic, wireless, or optical links. Communication interface 660 may be configured to use Time Division Multiplex (TDM), Internet Protocol (IP), Ethernet, optical networking, wireless protocols, communication signaling, or some other communication format—including combinations thereof. Communication interface 660 may be configured to communicate with one or more hosts as part of a computing environment.

Processing system 650 comprises microprocessor and other circuitry that retrieves and executes operating software from storage system 645. Storage system 645 may include volatile and nonvolatile, removable, and non-removable media implemented in any method or technology for storage of information, such as computer readable instructions, data structures, program modules, or other data. Storage system 645 may be implemented as a single storage device but may also be implemented across multiple storage devices or sub-systems. Storage system 645 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no case is the storage media a propagated signal.

Processing system 650 is typically mounted on a circuit board that may also hold the storage system. The operating software of storage system 645 comprises computer programs, firmware, or some other form of machine-readable program instructions. The operating software of storage system 645 comprises virtual machine (VM) resource module 620 and migrate module 622. The operating software on storage system 645 may further include an operating system, utilities, drivers, network interfaces, applications, or some other type of software. When read and executed by processing system 650 the operating software on storage system 645 directs management computing system 600 to operate as a management service described herein in FIG. 1-5.

In at least one implementation, VM resource module 620 directs processing system 650 to identify one or more virtual machines in a computing environment with a misconfiguration or overlapping NUMA node assignments. The one or more virtual machines can execute across a plurality of hosts in a computing environment, wherein each of the hosts can comprise multiple NUMA nodes that each include one or more processors and memory. VM resource module 620 directs processing system 650 can identify configurations associated with the virtual machines from a user, or the hosts can indicate the processors and NUMA nodes for each of the virtual machines.

Once the one or more virtual machines are identified, VM resource module 620 selects a virtual machine of the one or more virtual machines and determines whether a NUMA node for the virtual machine satisfies one or more criteria to trigger a migration of a virtual machine associated with the NUMA node to another NUMA node. In some examples, VM resource module 620 can select a virtual machine based on a severity of resource limitations associated with the virtual machine. The resource limitations can include processing resource limitations (i.e., overlap with other virtual machines, percent usage of the cores, and the like), memory resource limitations (e.g., memory requirements of the virtual machine, memory usage of the NUMA nodes exceeding a threshold quantity), or some other resource limitation. The VM with the highest rank can be selected prior to other virtual machines. In other examples, the virtual machine can be selected at random, can be selected based on a quality of service associated with the virtual machine, or based on some other factor.

After the virtual machine is selected, VM resource module 620 can direct processing system 650 to determine whether the NUMA node for the virtual machine satisfies one or more criteria. The one or more criteria can include the amount of processing resources being consumed at the NUMA node exceeding a threshold, the amount of memory resources being consumed at the NUMA node exceeding the threshold, or some other criteria, including combinations thereof. If the NUMA node does not satisfy the criteria, then VM resource module 620 may not take an action to migrate a virtual machine from the NUMA node and can move to another identified virtual machine with potential conflicts or misconfigurations. If the NUMA node does satisfy the criteria, migrate module 622 directs processing system 650 to select a virtual machine associated with the NUMA node for migration. Migrate module 622 can select a virtual machine based on the memory resources required for the virtual machine, processing resources required by the virtual machine, or based on some other factor.

For example, three virtual machines may execute on the same NUMA node on a first host and migrate module 622 can identify a first virtual machine that uses the least amount of memory on the NUMA node. Once identified, migrate module 622 can determine whether the NUMA node includes enough resources to support the remaining two virtual machines. If the NUMA node includes enough resources (i.e., processors and memory) to support the remaining virtual machines, then the first virtual machine can be migrated to another NUMA node. If the NUMA node does not include enough resources to support the remaining virtual machines, migrate module 622 can select a second virtual machine on the NUMA node with the next lowest amount of memory requirements and repeat the steps of determining whether the NUMA node can support the remaining virtual machines if the second virtual machine is migrated. Migrate module 622 can repeat the operation as necessary until a virtual machine is identified that can be migrated with the NUMA node providing enough resources to the remaining virtual machines. If no virtual machine can be identified, then a notification can be provided to an administrator of the computing environment indicating an issue with the NUMA node.

When a virtual machine is selected for migration, migrate module 622 can select a host and NUMA node for the selected virtual machine. In at least one example, migrate module 622 directs processing system 650 to determine whether a second NUMA node exists on the same host with resources to support the migrating virtual machine. The NUMA node must include processor resources and memory resources to support the migrating virtual machine. If the NUMA node exists, migrate module 622 initiates a migration to the second NUMA node on the same host. Advantageously, data is not required to be communicated to another host in the computing environment. If the same host does not include a NUMA node with resources to support the virtual machine, migrate module 622 can direct processing system 650 to identify a second NUMA node on another host to support the migrating virtual machine. When another host is identified, migrate module 622 directs processing system 650 to initiate a migration of the virtual machine to the NUMA node on the identified host. If no other NUMA node in the computing environment can support the migrating virtual machine, then no migration will be implemented and migrate module 622 can generate a notification for a user that indicates inability to migrate the virtual machine.

Although demonstrated in the previous example as migrating a virtual machine to another NUMA node based on resource usage in association with a current NUMA node, VM resource module 620 may further monitor the resource usage associated with the virtual machines in a computing environment and generate a summary for an administrator of the computing environment. In at least one implementation VM resource module 620 directs processing system 650 to identify one or more virtual machines with overlapping resources on a NUMA node or misconfigured to an undesirable NUMA node (e.g., not enough processors or memory). The information can be supplied at least partially by the hosts in some examples, wherein the hosts can indicate the virtual machines and the corresponding resources available to the virtual machines. Once the virtual machines are identified, management service 115 can indicate the one or more virtual machines that are misconfigured or have overlapping allocation on a NUMA node (e.g., machines that share processors on a NUMA node). In some examples, VM resource module 620 can further identify current resources usage at the corresponding NUMA nodes. The resource usage can include processor resource usage, memory resource usage, or some other information in association with the NUMA node. The information can then be displayed as part of a summary associated with the computing environment, such that an administrator can take action to migrate one or more virtual machines or identify NUMA nodes that are incapable of supporting the virtual machine load.

The included descriptions and figures depict specific implementations to teach those skilled in the art how to make and use the best mode. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method comprising:
identifying one or more virtual machines in a computing environment with a misconfiguration or overlapping non-uniform memory access (NUMA) node assignments;
selecting a virtual machine from the one or more virtual machines;
determining whether a NUMA node for the virtual machine satisfies one or more criteria; and
when the NUMA node satisfies the one or more criteria, selecting a virtual machine for migration from a set of one or more virtual machines associated with the NUMA node.

2. The method of claim 1, wherein selecting the virtual machine from the one or more virtual machines comprises:
ranking the one or more virtual machines based on a severity of resource limitations associated with each of the one or more virtual machines;
selecting the virtual machine with a highest rank.

3. The method of claim 2, wherein the resource limitations comprise processor resource limitations or memory resource limitations.

4. The method of claim 1, wherein the one or more criteria comprises a memory availability for the virtual machine on the NUMA node being less than a memory requirement for the virtual machine, or a processor availability for the virtual machine on the NUMA node being less than a processing requirement for the virtual machine.

5. The method of claim 1, wherein selecting the virtual machine for migration from the set of one or more virtual machines associated with the NUMA node comprises:
(a) identifying a first virtual machine in the set of one or more virtual machines associated with the NUMA node with a lowest memory requirement;
(b) determining whether the NUMA node satisfies one or more criteria if the first virtual machine were migrated from the NUMA node;
(c) when the NUMA node satisfies the one or more criteria if the first virtual machine were migrated from the NUMA node, selecting the first virtual machine for migration; and
(d) when the NUMA node does not satisfy the one or more criteria if the first virtual machine were migrated from the NUMA node, repeating steps (b), (c), and (d) with a second virtual machine in the set of one or more virtual machines associated with the NUMA node with a next lowest memory requirement.

6. The method of claim 1, further comprising initiating a migration of the selected virtual machine for migration to a second NUMA node on a host with the NUMA node.

7. The method of claim 1, further comprising initiating a migration of the selected virtual machine for migration to a second NUMA node on a host different from the NUMA node.

8. The method of claim 1 further comprising:
identifying resource availability at one or more additional NUMA nodes;
selecting a second NUMA node from the one or more additional NUMA nodes based on the resource availability; and
initiating a migration of the selected virtual machine for migration to the second NUMA node.

9. The method of claim 1 further comprising:
identifying resource availability at one or more additional NUMA nodes on a host with the NUMA node;
determining whether a NUMA node of the one or more additional NUMA nodes can support the selected virtual machine for migration;
when a NUMA node of the one or more additional NUMA nodes can support the selected virtual machine for migration, selecting the NUMA node of the one or more additional NUMA nodes for migration;
when a NUMA node of the one or more additional NUMA nodes cannot support the selected virtual machine for migration, determining whether a NUMA node on one or more additional hosts can support the selected virtual machine for migration;
when a NUMA node on the one or more additional hosts can support the selected virtual machine, selecting the NUMA node from the one or more additional hosts for migration; and
when a NUMA node on the one or more additional hosts cannot support the selected virtual machine, generating a notification that no migration is available for the selected virtual machine.

10. A computing apparatus comprising:
a storage system;
a processing system is operatively coupled to the storage system; and
program instructions stored on the storage system that, when executed by the processing system, direct the computing apparatus to:
identify one or more virtual machines in a computing environment with a misconfiguration or overlapping non-uniform memory access (NUMA) node assignments;
select a virtual machine from the one or more virtual machines;
determine whether a NUMA node for the virtual machine satisfies one or more criteria; and
when the NUMA node satisfies the one or more criteria, select a virtual machine for migration from a set of one or more virtual machines associated with the NUMA node.

11. The computing apparatus of claim 10, wherein selecting a virtual machine from the one or more virtual machines comprises:
ranking the one or more virtual machines based on a severity of resource limitations associated with each of the one or more virtual machines;
selecting the virtual machine with a highest rank.

12. The computing apparatus of claim 11, wherein the resource limitations comprise processor resource limitations or memory resource limitations.

13. The computing apparatus of claim 11, wherein the one or more criteria comprises a memory availability for the virtual machine on the NUMA node being less than a memory requirement for the virtual machine, or a processor availability for the virtual machine on the NUMA node being less than a processing requirement for the virtual machine.

14. The computing apparatus of claim 10, wherein selecting the virtual machine for migration from the set of one or more virtual machines associated with the NUMA node comprises:
(a) identifying a first virtual machine in the set of one or more virtual machines associated with the NUMA node with a lowest memory requirement;
(b) determining whether the NUMA node satisfies one or more criteria if the first virtual machine were migrated from the NUMA node;
(c) when the NUMA node satisfies the one or more criteria if the first virtual machine were migrated from the NUMA node, selecting the first virtual machine for migration; and
(d) when the NUMA node does not satisfy the one or more criteria if the first virtual machine were migrated from the NUMA node, repeating steps (b), (c), and (d) with a second virtual machine in the set of one or more virtual machines associated with the NUMA node with a next lowest memory requirement.

15. The computing apparatus of claim 10, wherein the program instructions further direct the computing apparatus to initiate a migration of the selected virtual machine for migration to a second NUMA node on a host with the NUMA node.

16. The computing apparatus of claim 10, wherein the program instructions further direct the computing apparatus to initiate a migration of the selected virtual machine for migration to a second NUMA node on a host different from the NUMA node.

17. The computing apparatus of claim 10, wherein the program instructions further direct the computing apparatus to:
identify resource availability at one or more additional NUMA nodes;
select a second NUMA node from the one or more additional NUMA nodes based on the resource availability; and
initiate a migration of the selected virtual machine for migration to the second NUMA node.

18. The computing apparatus of claim 10, wherein the program instructions further direct the computing apparatus to:
identify resource availability at one or more additional NUMA nodes on a host with the NUMA node;
determine whether a NUMA node of the one or more additional NUMA nodes can support the selected virtual machine for migration;
when a NUMA node of the one or more additional NUMA nodes can support the selected virtual machine for migration, select the NUMA node of the one or more additional NUMA nodes for migration;
when a NUMA node of the one or more additional NUMA nodes cannot support the selected virtual machine for migration, determine whether a NUMA node on one or more additional hosts can support the selected virtual machine for migration;
when a NUMA node on the one or more additional hosts can support the selected virtual machine, select the NUMA node from the one or more additional hosts for migration; and
when a NUMA node on the one or more additional hosts cannot support the selected virtual machine, generate a notification that no migration is available.

19. A method comprising:
identifying one or more virtual machines in a computing environment with a misconfiguration or overlapping non-uniform memory access (NUMA) node assignments;
for each virtual machine of the one or more virtual machines, identifying resource usage in association with a NUMA node for the virtual machine; and
identifying at least one virtual machine of the one or more virtual machines with resource usage that satisfies one or more criteria;
generating a display indicating the at least one virtual machine.

20. The method of claim 19, wherein the one or more criteria comprises a threshold amount of memory usage associated with the NUMA node, or a threshold processor resource usage associated with the NUMA node.
